(19) United States
(12) Patent Application Publication
(10) Pub. No.: US 2005/0007911 A1
(43) Pub. Date: Jan. 13, 2005

(54) Method for recording data on a data storage medium enabling data identification

(76) Inventors: Sergei Petrovich Kotikov, Penza (RU); Igor Fedorovich Ivlev, Tuchkovo (RU)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/495,590

(22) PCT Filed: Jul. 19, 2002
(86) PCT No.: PCT/RU02/00343

(30) Foreign Application Priority Data
Nov. 16, 2001 (RU) 2001130955

(51) Int. Cl. G11B 5/09

(52) U.S. Cl. 369/47.21; 369/59.25; 369/47.55

(57) ABSTRACT

The invention relates to methods for recording data on an information medium such as, for example a CD or DVD, and can be used for protecting data against non-authorised coping, identifying data storage media and for data validation. The inventive method consists in forming a data file in the form of a first data sector sequence, the sector addresses of the sequence being embodied in the form of a sequence of natural numbers, recording the first sequence of the formed sectors with respective addresses on a spiral track. In addition, during the formation of the first sector sequence, at least one second data sector sequence whose sector addresses at least partially coincide with the sector addresses of the first sequence is formed, the number of coinciding addresses is equal to C and is not less than the number of data sectors recorded on two adjacent turns of the spiral track in an area which corresponds to the addresses of the sectors. Key data is registered in sectors having the coinciding addresses. Any digital reader can be used for reading out data from the discs.

### FIELD OF THE INVENTION

The group of inventions relates for methods of recording data on a medium whereby the data is recorded concentrically. These media can be, for example, CD or DVD discs. The group of inventions can be used for protecting data recorded concentrically against illegal copying. The inventions can be used further as a means to identify media, i.e., for example, to determine whether the user has a legal or an illegal medium. These methods can be used still further to verify data recorded on media with identifying key data.

### BACKGROUND ART

CD disc recording methods are known, where the authenticity of a CD is verified using a special equipment, which makes it possible to use illegal copies as authentic ones and to reformation recorded on a disc.

A CD ROM disc recording method is known, based on writing a program on a CD ROM disc to protect the information recorded on the disc against illegal copying, whose cost is low, including the protective application. This program application is designed to handle a “protection key”, the disc being specifically processed during manufacturing to form a check ring. This system uses a special method for verifying the authenticity of the check ring. The insertion of the check ring using the authenticity verification makes it impossible to copy a CD ROM disc even by a very sophisticated recording equipment.

This method offers many advantages as compared to other methods of protection, such as low cost combined with excellent protection.

The method can be also used to protect PC software designed to handle CD ROMs and to operate in DOS or Windows (U.S. Pat. No. 6,101,476 A, G 06 F 17/60, Aug. 8, 2000).

The known method has two features: a special way of manufacturing CD discs and the software for the disc authentication.

Methods of recording read-only data written on a CD ROM disc are known, whereby various check (key) data are written on a disc in addition to data for reading, this key data being extracted and used to restore the data for reading but are lost when an attempt is made to copy the CD ROM disc (WO 00 4053, G 11 B 20/00, Apr. 13, 2000; WO 00 62293, G 11 B 20/00, Oct. 19, 2000; and WO 00 21086, G 11 B 20/00, Apr. 13, 2000).

The closest prior art of the invention is the method of data protection according to U.S. Pat. No. 6,101,476 A.

The disadvantage of the prior art method is the presence of the disc authentication software, which increases the manufacturing cost while the part of the disc surface used to write the authentication program reduces the surface area for recording useful information.

### SUMMARY OF THE INVENTION

The technical effect of the claimed data recording methods is expansion of the field of application of recording methods because any digital reading equipment can be used to read data from discs. This feature simplifies the verification procedure and reduces the cost of all service equipment.

Thus the level of protection against copying is raised considerably.

Still another technical effect of the claimed methods is a greater protection of data recorded on media, the data becoming impossible to read from a copy made illegally. This method makes it possible not to find any recording errors when such media are checked on a quality control apparatus during production, for example, to detect defects, or during playback by a standard reading device, for example, a CD ROM driver. The method ensures that data recorded on such media can be only read from an original disc made legally.

At the same time, the data can still be copied, for example, to a hard disc maintaining the initial recording standards, but to retrieve these data for further use by means of, for example, a CD ROM driver requires the presence of the original disc.

The technical effect in the first embodiment is accomplished by that, in a data recording method, a data file is formed for recording, which contains the first sequence of sectors with data, whose sector addresses represent a series of natural numbers; and the first sequence of the formed sectors with appropriate addresses is recorded on a spiral track, the file thus formed is written on a medium after forming and recording at least one second sequence of data sectors to said file, the addresses of the sectors in the second sequence matching, at least in part, sector addresses of the first sequence, the number of the matching addresses being “c” and equaling at least the number of the data sectors recorded on two adjacent turns of the spiral track in an area that corresponds to the addresses of these sectors, while the address of the first sector of the second sequence is selected to be equal to the address of the last sector of the first sequence minus said number “c”, and the sectors of the second sequence with said addresses are written after the sectors of the first sequence are recorded.

In the process, the data for the recording are the user data and key data, the former being intended for forming and recording the first sequence of sectors and the second sequence with mismatching sector addresses, while the key data are intended for forming and recording the sectors of the second sequence with matching addresses.

The data medium is identified while reading the data or the key data of the second spiral track, whose address matches that in the first sequence.

In the claimed embodiment of the method, the above-mentioned sectors of the second sequence can be written with an interval after the sectors of the first sequence.

A meander-shaped digital signal can be recorded in the interval on the spiral track.

The technical effect in the second embodiment is accomplished by that, in the data recording method consisting in forming a data file for recording as the first sequence of data sectors, whose sector addresses represent a series of natural numbers, the first recording means writes the first sequence of sectors formed with appropriate addresses on the fist spiral track, the second sequence of sectors with appropriate addresses is formed, the formed first sequence is recorded up to a sector with a specified address A1 and with an initially preset distance between adjacent turns of the spiral track with the recorded data, and then this distance is changed in the process of recording to a value of about twice the initially preset distance between the turns of the spiral track, continuing the recording of the first sequence on the first track; the second recording means is set up at an initially preset distance from the appropriate turn of the first track and data are written in parallel on the first spiral track and on the second spiral track of the sectors of the first sequence and of the second sequence, respectively, and when the sector A2≧A1+C is recorded, where C is the number of the data sectors that can be recorded on two adjacent turns of the spiral track, the recording on the second track is stopped, the distance between the turns of the first track is changed to the value of the initially preset distance and the recording of the sectors of the first sequence is resumed, the addresses of the sectors of the first sequence and the addresses of the second sequence with addresses from A1 to A2 are matched.

In the process, the data for recording are the user data and key data, the former are intended for forming and recording the first sequence of sectors, and the key data are intended for forming and recording the sectors of the second sequence.

The data medium is identified with specified data or key data from the second spiral track.

The technical effect in the third embodiment is accomplished by that, in the data recording method consisting in forming a data file for recording as the first sequence of sectors with data, whose sector addresses represent a series of natural numbers, the first sequence of sectors formed with appropriate addresses is recorded on the first spiral track, the second sequence of sectors with appropriate addresses is formed, the first formed sequence is recorded up to a sector with a specified address A1 and with an initially preset distance between adjacent turns of the first spiral track, and then this distance is changed in the process of recording at least to a value that is twice the initially preset distance; after the sector of the first sequence with the address A2≧A1+C is written, this distance is changed to the initially preset value and the recording of the first sequence is continued to the end; after the first sequence is recorded, the recording means is returned to the area of the recorded sector with the address A1 on the spiral track and this means is offset relative to the first track by the value of the initially preset distance between the turns of revolutions of the first spiral track, and the second sequence of sectors is recorded in the interval between the turns of the first spiral track with the recorded sectors of the first sequence, the recording on the second track being stopped when the sector A2≧A1+C is written, where C is the number of data sectors that can be recorded on two adjacent turns of the spiral track.

Here, the data for recording on the disc are the user data and key data, the former are intended for forming and recording the first sequence of sectors, and the key data are intended for forming and recording sectors of the second sequence. The identification is carried out as data is read from the second spiral track.

### EXAMPLES OF EMBODIMENTS

The method according to the first embodiment is based on that the data recording on a spiral track forms turns of this track as sectors with data. The data is formed as a file which is a sequence of data sectors provided with addresses. The sequence of the addresses of such sectors is normally a natural series of numbers. A specific feature of a reading device is that when a certain sector address is specified and is searched, the reading device calculates its own movement relative to the latest location and can move along the radius of a track by the number of sectors of no less than the number “c” that is equal or corresponds to the number of the sectors which were recorded on adjacent turns of the spiral track.

Given these prerequisites, the first embodiment of the method is proposed, wherein data files are formed as the first sequence of data sectors before the data are recorded, the addresses of the sectors representing a natural series of numbers, for example, in the following form:
N, N+1, N+2, . . . , N+n

Then, at least one second sequence of data sectors is formed as:
N+1, N+2, . . . , N+n, N+n+1, N+n+2, . . . , and the addresses of the sectors N+1, N+2, . . . , N+n is the second sequence match, at least in part, the addresses of sectors in the first sequence, the number of the matching addresses being equal to or of the same order with “c”, which corresponds to the number of data sectors recorded on any two adjacent turns of the spiral track, while the address of the first sector N+1 in the second sequence is selected to be equal to the address of the last sector N+n in the first sequence minus the number “c” and the above-mentioned file is formed by recording sectors of the second sequence with these addresses after the sectors of the first sequence are recorded. Then the file thus formed is written to the medium. The medium is verified as it is read by a standard reading apparatus.

It should be noted that, while manufacturing the medium and recording the user data, the reading program data to be rewritten to the memory of the reader-controlling computer, which data are used in reading data from the medium, are also recorded on the disc.

Thus, data are read from the medium using the data of the reading program, which include also the data about the sectors with matching addresses, with the help of which the reader determines the legality of a disc and also utilized the key data to ensure the use of the user data.

Reading according to the first embodiment can be carried out as follows. It was stated above that, while searching for a specified sector address, the reader calculates the value of relative movement of the reading head relative to its latest location (the last address it passed).

The sequence of data reading by the reader in accordance with the data of said reading program is as follows.

The address of a sector in the first sequence, which does not match the addresses of the second sequence, is specified for indirect positioning of the reading head (binding to the latest reading address). Then the address of a sector in the first sequence, which is one of the matching addresses, is specified and this sector in the first sequence is found. Then the address of a sector in the second sequence, which does not match the addresses of the first sequence, is specified whereupon the sector containing key data with the specified address in the second sequence is found when an address that matches these matching addresses of the first sequence and of the second sequence is specified, the key data provide further use of the data.

As it was mentioned above, normal data for recording on a medium include user data and key data, and the former can be used, for example, for forming and recording the first sequence of sectors, while the key data are intended for forming and recording the sectors of the second sequence with matching addresses. And the second sequence can include, in addition to the sectors with matching addresses, also the user data. It should be noted that it is preferred that the key data be recorded in the sectors with matching addresses in the first sequence and second sequence as data are written on a medium because the data in the sectors with matching addresses of the second sequence will be lost when an attempt is made to manufacture the medium illegally.

The method can be realized with an additional protection against copying. For this purpose, said sectors of the second sequence are recorded with an interval after the sectors of the first sequence.

This interval can be a digital signal recorded on a spiral track in the form of a meander and this signal will make data reading for copying still more difficult.

That is, data can be recorded between the first sequence and second sequence with a short time delay for the period of automatic “gap” between the sequences; in this case the data of the sectors with matching addresses in the matching addresses in the second sequence will not be read in the process of copying (to an illegal disc).

In other words, the insertion of a “hole”, i.e., the absence of data, between the first sequence and the second sequence of a sector results in during an attempt at copying a disc with such a “hole” these data from sectors being “read” will be written onto the copy of the disc instead of the “hole” and data from a certain part of the sectors beyond the “hole”, i.e., data with matching addresses, will be lost.

Thus, recording data to the sectors whose addresses make a certain sequence (1), (2) or a sequence of sectors with missing data in an appropriate area of a track, i.e. “hole”, can ensure even better protection of the data on a disc against copying because, if the disc is legal, the data will be read according to the reading program taking into account the special features of recording; hence the data thus read can be used further, while the key data will be lost in coping (to an illegal disc). So, the verification, including identification of the data medium, is carried out during data reading. It means that, if a disc is illegal, it will be read in copying by a standard reading device without the specific features of the original recording, and thus the data will be unusable further.

The realization of the method in the second and third embodiments involves the following actions.

It is worth repeating that a spiral track is formed as data is recorded on a disc. Pits located in a row form a recording track with appropriate information in the digital format. The minimum length of a pit is 0.9 microns. The distance between adjacent turns of the track in a digital disc is 1.6 microns, which corresponds approximately to 625 tracks (revolutions of a track) per 1 mm. As a disc is scanned by a laser, its beam is reflected completely back in the areas that do not have pits while the pit areas scatter the beam, and these signals are sensed by a photoelectric detector and converted to appropriate digital signals which are used then to transform the data being read into sound, images, etc. And the data reading from the optical disc is controlled by a preset reading program that moves the reading head relative to the data-containing spiral tracks of the disc.

Modern digital reader-players can control the reading process being able to find the beginning of a record fragment (sector address) and to read the data in the sector. Hence, it is possible to have different disc recording modifications using standard recording devices and standard reading devices. Data can be recorded on tracks, for example, while inserting additional tracks, although it is necessary to take into account the requirements for disc recording density in this case.

In addition, to read data from a medium, the memory of the computer that controls the reading equipment contains a reading program that in data reading process reads also data from the medium to be stored in the computer memory, this data being intended for using the data recorded on the medium.

In view of this circumstances, the recording method in the second embodiment can be used as follows. First, the user data and key data, i.e., data to be recorded on a medium, form data files as the first sequence of sectors with the user data. The addresses of the sectors in the first sequence normally represent a natural series of numbers, and in addition they form the second sequence of sectors with the key data, the sectors being provided with appropriate addresses.

The first sequence of the sectors with appropriate addresses thus formed starts to be recorded as the first spiral track, the recording being carried out by a recording means with a standard distance (pitch) between the adjacent turns of the spiral track (the initially preset distance is normally about 2.4 microns). As data is recorded in a sector, for example, with the address A1, the above distance is gradually changed in the process of recording to a value of about twice the initially preset distance, and the data of the first sequence to be recorded on the first track. Then the second recording means is switched on at the initially preset distance from the turn of the first spiral track in the area where no data was recorded yet, and the data of the second sector sequence starts to be recorded by the second recording means on the second spiral track located between the turns of the first track in parallel to the record on the first track. And the distance, as it was mentioned above, between the turns of the first track and second track with the recorded data of the first sequence and second sequence corresponds to the initially preset distance. When the sector A2≧A1+C is recorded, where C is the number of data sectors that can be recorded on two adjacent turns of the spiral, the recording on the second track is stopped, the distance between the turns of the first track is changed to the value of the initially preset distance and the recording of the sectors in the first sequence is resumed. The addresses of the first sequence and the addresses of the second sequence on the first and second tracks from A1 to A2 are matched.

Thus, the data will be recorded in the area of the spiral track on two tracks of the medium starting from the address of approximately sectors A1 to A2. As it was mentioned above, it is preferred that the user data should be recorded on the first track, while the key data should be recorded on the second additional track between the turns of the first track. The third embodiment of the method differs from the second in the sequence of actions when data is recorded on the first and second tracks.

In the third embodiment, a data file is also formed first as the first sequence of sectors with data provided with appropriate addresses representing, for example, a natural series of numbers. The second sequence of data sectors is also formed, the sectors being provided with appropriate addresses. One recording means is used for this method. Data is recorded on a medium with the help of one recording means. The first sequence of the formed sectors with appropriate addresses is recorded in the form of the first spiral track. The first formed sequence is recorded up to a sector with the specified address A1 and with an initially preset distance between the adjacent turns of the spiral track with the recorded data, then this distance is increased in the process of recording to a value of double initially preset distance between the adjacent turns of the first track and the recording continues up to the address A2≧A1+C whereupon this distance is changed to the initially preset one, the recording of the first sequence on the first track is resumed; after the first sequence is recorded the recording means is transferred to the area of the address of sector A1 with the increased distance between the turns of the first track, and the second sequence of sectors is recorded.

Thus, the data of the first sequence of sectors and of the second sequence of sectors will be recorded on the medium starting from a sector with the address A1 to a sector with the address A2, i.e. the data of the sectors in the second sequence will be recorded in an interval between the turns of the first track with the recorded data of the sectors in the first sequence, the addresses of the sectors in the first sequence and the addresses of the sectors in the second sequence are matched on the first and second tracks from A1 to A2 in this area.

The data recorded on a medium in the second embodiment and in the third embodiment is verified while reading the data by a reading device as follows.

As it was mentioned, hidden data, which is normally the key data, is recorded on a medium on the second spiral track located between the turns of the first spiral track.

In this area, the addresses of the sectors of the first sequence recorded on the first track and of the second sequence recorded on the second track match; these are addresses from A1 to A2, while A2≧A1+C where C is the number of sectors, which can be recorded on two adjacent turns of a track in the area of appropriate addresses. By specifying a certain sequence of addresses in this area to a reading device, a sector with one of the addresses from A1 to A2 in the second sequence of the data recorded on the second track can be found out by successive approximations. It is done as follows. Indirect positioning is carried out, for example, by finding a sector in the first sequence, for example, with an address up to A1. In this case, the reading device is located, for example, towards the center of the concentric record relative to the second track.

Since the reading device calculates its movement relative to its latest position (the number of spiral track turns that the reading device-has to cross) while data reading in order to move to the recorded area in the track with sectors whose addresses are less than specified addresses by the value “c”, then an address between A1 and A2 is specified to the reading device, the reading device moves to the area with matching addresses. In this case, the reading device can get to the sector with the matching address recorded on the second track by searching addresses first up the address A1, then any of those addresses that match A1 up to A2, and then an address greater than A2, meanwhile constantly positioning itself. To improve the accuracy of determining, finding, and subsequent reading data in the second track, each of the sectors with the addresses A1 to A2 in the second sequence is provided with a check character or characters. And as the reading device reads data from the sectors specified to it in the process of the search, it constantly checks the data for the presence of the check character. Having found this character, the reading device reads the data.

In case data is read from any of the sectors in the second sequence, the medium is simultaneously identified. And the reading device can issue a message, for example, that the medium is legal.

### INDUSTRIAL APPLICABILITY

The present invention allows to verify the authenticity of discs without using special equipment and can be widely used in manufacturing CD or DVD discs.

1. A method for recording data on a medium, in which a data file for recording is formed, said file containing the first sequence of sectors with data, whose sector addresses represent a series of natural numbers, for recording the first sequence of the formed sectors with appropriate addresses on a spiral track, characterized in that the formed file is recorded on a medium after at least one second sequence of sectors with data was formed and was recorded to said file, the addresses of the sectors in the second sequence matching at least in part the addresses of sectors in the first sequence, the number of the matching addresses being “c” and equaling at least the number of data sectors recorded in two adjacent turns of a spiral track in the area that corresponds to the addresses of these sectors, and the address of the first sector in the second sequence being selected to be equal to the address of the last sector in the first sequence minus said number “c” and the sectors in the second sequence with said addresses being recorded after recording the sectors in the first sequence.

2. A method as claimed in claim 1 characterized in that the data for recording include the user data and key data, the former are intended for forming and recording the first sector sequence and the second sequence with mismatching sector addresses, and the key data are intended for forming and recording the sectors of the second sequence with matching addresses.

3. A method as claimed in claim 1 or in claim 2 characterized in that a medium is identified as data or the key data is read from the second spiral track.

4. A method as claimed in claim 1 or in claim 2 characterized in that said sectors of the second sequence are recorded with an interval after the sectors of the first sequence.

5. A method as claimed in claim 4 characterized in that a digital signal in the form of a meander is recorded in said interval on the spiral track.

6. A method for recording data on a medium, which consists in that a data file is formed for recording as the first sequence of sectors with data, whose sector addresses represent a series of natural numbers, for recording the first sequence of the formed sectors with appropriate addresses on the spiral track characterized in that the second sequence of sectors with appropriate addresses is formed, a recording means records the first formed sequence on the first spiral track up to a sector with a specified address A1 and with an initially preset distance between adjacent turns of the spiral track with the recorded data, then said distance is changed in the process of recording to a value of about twice the initially preset distance between the turns of the spiral track, the second recording means is set up while the first sequence is still being recorded on the first track at the initially preset distance from the appropriate turn of the first track, and the data are recorded in parallel to the sectors in the first sequence and second sequence on the first spiral track and on the second spiral track, respectively, and when the sector A2≧A1+C, where C is the number of the data sectors that can be recorded on two adjacent turns of a spiral track, is recorded, the recording on the second track is stopped, the distance between the turns of the first track is changed to the initially preset distance, and the recording of the sectors in the first sequence is continued, the addresses of sectors in the first sequence and the addresses of sectors in the second sequence on the first and second spiral tracks from A1 to A2 are matched.

7. A method as claimed in claim 6 characterized in that data for recording on a disc include the user data and key data, the former are intended for forming and recording the first sequence of sectors and the key data are intended for forming and recording sectors in the second sequence.

8. A method as claimed in claim 6 or 7, characterized in that a medium is identified as data or key data is read from the second spiral track.

9. A data recording method enabling identification, which consists in that a data file for recording is formed as the first sequence of sectors with data, whose sector addresses represent a series of natural numbers, for recording the first sequence of the formed sectors with appropriate addresses on a spiral track, characterized in that the second sequence of sectors with appropriate addresses is formed, the first formed sequence is recorded to a sector with the specified address A1 and with an initially preset distance between adjacent turns of the first spiral track, then said distance is increased in the process of recording to a value of at least twice the initially preset distance, after the sector of the first sequence with the address A2≧A1+C is recorded said distance is changed to the initially preset distance and the recording of the first sequence continues to the end; the first sequence having been recorded on the first spiral track, the recording means is returned to the area where the sector with the address A1 was recorded and the writing head is offset relative to the first spiral track by the value of the initially preset distance between the turns of revolutions of the first spiral track, the second sequence of sectors is recorded in an interval between the turns of the first spiral track and the recording on the second track is stopped when the sector A2≧A1+C is recorded, where C is the number of the data sectors that can be recorded on two adjacent turns of the spiral track in the area of the sectors with said addresses, the sectors in the first sequence matching the sectors in the second sequence on the first and second spiral tracks from A1 to A2.

10. A method as claimed in claim 9 characterized in that data for recording include the user data and key data, the former are intended for forming and recording the first sequence of sectors, and the key data are intended for forming and recording sectors in the second sequence.

11. A method as claimed in claim 9 or 10 characterized in that a medium is identified as data or key data is read on the second spiral track.
